(19) United States
(12) Patent Application Publication
(10) Pub. No.: US 2025/0230739 A1
(43) Pub. Date: Jul. 17, 2025

(54) PROCESSING FLOWBACK PRODUCED WATER FOR CARBON CAPTURE AND UTILIZATION

(71) Applicant: Saudi Arabian Oil Company, Dhahran (SA)

(72) Inventors: Sarah Yacob Alaskar, Dhahran (SA); Abeer Ateeq Alarawi, Al Khobar (SA); Murtadha J. AlTammar, Dhahran (SA)

(21) Appl. No.: 18/415,315

(22) Filed: Jan. 17, 2024

(51) Int. Cl. E21B 43/34; C09K 8/62; E21B 41/00; E21B 43/26

(52) U.S. Cl. CPC E21B 43/34; C09K 8/62; E21B 41/0064; E21B 43/26

(57) ABSTRACT

A flowback produced water stream is received from a hydraulically fractured well formed in a subterranean formation. The flowback produced water stream includes water, dissolved solids comprising divalent cations, and carbon dioxide. The flowback produced water is flowed to a membrane. The membrane separates at least a portion of the dissolved solids from a remaining portion of the flowback produced water to produce a waste stream and a filtered produced water stream. The filtered produced water stream is reacted with an alkali hydroxide to precipitate carbonates from the carbon dioxide molecules and the divalent cations, thereby mineralizing the carbon from the filtered produced water stream into carbonate precipitates. The carbonate precipitates are separated from a remainder of the filtered produced water stream.

### TECHNICAL FIELD

This disclosure relates to carbon capture and utilization, and in particular, carbon capture from flowback produced water from wells.

### BACKGROUND

Carbon is an abundant element in the Earth's crust. Carbon's abundance, its diversity in the makeup of organic compounds, and its ability to form polymers at temperatures commonly encountered on Earth allows this element to serve as a common element of all known life. The atoms of carbon can bond together in numerous ways, resulting in various allotropes of carbon. Some examples of allotropes of carbon include graphite, diamond, amorphous carbon, carbon nanotubes, carbon fibers, and fullerenes. The physical properties of carbon vary widely based on the allotropic form. As such, carbon is widely used across various markets at commercial or near-commercial scales.

There is a growing interest in the energy transition from fossil fuels to renewable energy and sustainable energy in a global effort to reduce carbon emissions. Some examples of decarbonization pathways in the energy transition to renewable energy include increasing energy efficiency, producing and/or using lower-carbon fuels, and carbon capture and storage (CCS).

### SUMMARY

This disclosure describes technologies relating to carbon capture and utilization, and in particular, processing produced water from hydraulic fracturing operations for capturing and utilizing carbon. Certain aspects of the subject matter described can be implemented as a method. A flowback produced water stream from a hydraulically fractured well formed in a subterranean formation is received at a surface location. The flowback produced water stream includes water, dissolved solids comprising divalent cations, and carbon dioxide. The flowback produced water is flowed to a membrane. The membrane separates at least a portion of the dissolved solids from a remaining portion of the flowback produced water to produce a waste stream and a filtered produced water stream. The waste stream includes the portion of the dissolved solids separated by the membrane. The filtered produced water stream includes the remaining portion of the flowback produced water. The membrane is configured to allow passage of divalent cations, water molecules, and carbon dioxide molecules through the membrane while preventing at least the portion of the dissolved solids from passing through the membrane, such that the filtered produced water stream includes the divalent cations, water molecules, and carbon dioxide molecules. The filtered produced water stream is reacted with an alkali hydroxide to precipitate carbonates from the carbon dioxide molecules and the divalent cations, thereby mineralizing the carbon from the filtered produced water stream into carbonate precipitates. The carbonate precipitates are separated from a remainder of the filtered produced water stream.

This, and other aspects, can include one or more of the following features. In some implementations, the alkali hydroxide is selected from the group consisting of sodium hydroxide and potassium hydroxide. In some implementations, the divalent cations include calcium cations. In some implementations, the carbonate precipitates include calcium carbonate. In some implementations, the method includes adding the calcium carbonate in a formulation for marble or cement. In some implementations, the method includes flowing the filtered produced water stream into a second well formed in the subterranean formation. In some implementations, the divalent cations include magnesium cations. In some implementations, the carbonate precipitates include magnesium carbonate. In some implementations, the method includes adding the magnesium carbonate in a formulation for a brick, a fire extinguisher, a cosmetic, or a dusting powder. In some implementations, the method includes flowing the filtered produced water stream into a second well formed in the subterranean formation.

Certain aspects of the subject matter described can be implemented as a method. A fracturing fluid including carbon dioxide is injected into a wellbore formed in a subterranean formation, thereby hydraulically fracturing the subterranean formation. After injecting the fracturing fluid into the wellbore to hydraulically fracture the subterranean formation, a flowback produced water stream is flowed out of the wellbore. The flowback produced water stream is received at a surface location. The flowback produced water stream includes dissolved solids and water from the subterranean formation and at least a portion of the fracturing fluid. The flowback produced water stream is flowed to a membrane located at the surface location. The membrane separates at least a portion of the dissolved solids from a remaining portion of the flowback produced water stream to produce a waste stream and a filtered produced water stream. The waste stream includes the portion of the dissolved solids separated by the membrane. The filtered produced water stream includes the remaining portion of the flowback produced water stream. The filtered produced water stream is reacted with an alkali hydroxide to precipitate carbonates from the carbon dioxide molecules and at least a portion of the dissolved solids, thereby mineralizing the carbon from the filtered produced water stream into carbonate precipitates. The carbonate precipitates are separated from a remainder of the filtered produced water stream.

This, and other aspects, can include one or more of the following features. In some implementations, the alkali hydroxide is selected from the group consisting of sodium hydroxide and potassium hydroxide. In some implementations, the divalent cations include calcium cations. In some implementations, the carbonate precipitates include calcium carbonate. In some implementations, the method includes adding the calcium carbonate in a formulation for marble or cement. In some implementations, the method includes flowing the filtered produced water stream into a second well formed in the subterranean formation. In some implementations, the divalent cations include magnesium cations. In some implementations, the carbonate precipitates include magnesium carbonate. In some implementations, the method includes adding the magnesium carbonate in a formulation for a brick, a fire extinguisher, a cosmetic, or a dusting powder. In some implementations, the method includes flowing the filtered produced water stream into a second well formed in the subterranean formation.

Certain aspects of the subject matter described can be implemented as a system. The system includes a flowback produced water stream, a membrane, an inlet flowline, an outlet flowline, a reaction chamber, and an intermediate flowline. The flowback produced water stream is from a wellbore formed in a subterranean formation. The flowback produced water stream includes carbon dioxide, dissolved solids including divalent cations, and water. The membrane is positioned at a surface location. The membrane is configured to separate a portion of the dissolved solids from a remaining portion of the flowback produced water stream to produce a waste stream and a filtered produced water stream. The waste stream includes the portion of the dissolved solids separated by the membrane. The filtered produced water stream includes the remaining portion of the flowback produced water. The filtered produced water stream includes the divalent cations, the carbon dioxide molecules, and at least a portion of the water molecules. The inlet flowline is in fluid communication with the membrane. The inlet flowline is configured to flow the flowback produced water stream to the membrane. The outlet flowline is in fluid communication with the membrane. The outlet flowline is configured to flow the waste stream away from the membrane. The reaction chamber is configured to receive the filtered produced water stream and an alkali hydroxide. The reaction chamber is configured to hold the filtered produced water stream and the alkali hydroxide for a specified time duration to react the filtered produced water stream with the alkali hydroxide to precipitate carbonates from the carbon dioxide molecules and the divalent cations, thereby mineralizing the carbon from the filtered produced water stream into carbonate precipitates. The intermediate flowline is in fluid communication with the membrane and the reaction chamber. The intermediate flowline is configured to flow the filtered produced water stream from the membrane to the reaction chamber.

This, and other aspects, can include one or more of the following features. In some implementations, the system includes a second outlet flowline in fluid communication with the reaction chamber. In some implementations, the second outlet flowline is configured to flow a remaining portion of the filtered produced water stream free of the carbonate precipitates from the reaction chamber to a second well formed in the subterranean formation. In some implementations, the alkali hydroxide is selected from the group consisting of sodium hydroxide and potassium hydroxide. In some implementations, the divalent cations include calcium cations. In some implementations, the carbonate precipitates include calcium carbonate. In some implementations, the system includes a production unit. In some implementations, the production unit is configured to receive the calcium carbonate and add the calcium carbonate to a cement formulation to produce cement or to a marble formulation to produce marble. In some implementations, the divalent cations include magnesium cations. In some implementations, the carbonate precipitates include magnesium carbonate. In some implementations, the system includes a brick production unit. In some implementations, the brick production unit is configured to receive the magnesium carbonate and add the magnesium carbonate to a brick formulation to produce brick.

The details of one or more implementations of the subject matter of this disclosure are set forth in the accompanying drawings and the description. Other features, aspects, and advantages of the subject matter will become apparent from the description, the drawings, and the claims.

### DESCRIPTION OF DRAWINGS

FIG. 1A is a schematic diagram of an example well in which fluid is injected into the well.

FIG. 1B is a schematic diagram of an example well in which fluid is flowed out of the well.

FIG. 2A is a schematic diagram of an example flowback produced water processing unit for capturing carbon from flowback produced water from a well.

FIG. 2B is a schematic diagram of an example flowback produced water processing unit for capturing carbon from flowback produced water from a well.

FIG. 3 is a flow chart of an example method for processing flowback produced water from a well to capture carbon from the flowback produced water.

FIG. 4 is a flow chart of an example method for processing flowback produced water from a well to capture carbon from the flowback produced water.

### DETAILED DESCRIPTION

Carbon capture and storage is a worldwide attractive route to attenuating Carbon dioxide (CO₂) emissions and concentrations from the atmosphere. The emitted anthropogenic CO₂ from fossil fuel combustion strikes a vulnerability for climate change advocates and strides research initiatives for CO₂ capture and storage. Since the inauguration of the industrial revolution the world had seen a paradigm shift in the peculiarities of human activities. As a cause of the industrial revolution the concentrations of greenhouse gases (GHG), in general, and CO₂, in particular, have increased, reaching a peak of 409.8 parts per million (ppm) in 2019, higher than previous years. In comparison, prior to the industrial revolution the concentration of CO₂ fluctuated between 180 ppm to 280 ppm. This shift that struck the world inspired seeds of research opportunities to flourish and tackle solutions to reduce GHG and global CO₂ concentrations.

There are several solutions that strive to control CO₂ concentrations. These solutions include, for example, tree restoration, finding alternative fuel sources, direct air capture (DAC), and practicing carbon capture utilization and sequestration (CCUS). In tree restoration, CO₂ levels are reduced naturally through storing CO₂ in trees. Storing CO₂ from trees is a natural method to lower the concentrations of CO₂. In addition, tree restoration is relatively inexpensive compared to other conventional CO₂ control solutions. A disadvantage of tree restoration is that roots require large agricultural lands for reforestation, which can disrupt existing animal habitats. Alternative fuels are another solution for reducing CO₂ concentrations from the atmosphere. Alternative fuel sources can take on many forms, such as electrifying cars, electrifying ships, utilizing wind and solar energies, and using sustainable biofuels. Although utilizing alternative fuels can work as a sustainable substitute to conventional energy sources that capitalizes on burning fossil fuels, they still have several challenges. One challenge of alternative fuels sources is related to their low shelf life which does not last as long as conventional fuel sources. In addition, alternative fuel sources have environmental compatibility challenges. Direct air capture (DAC) is another method for controlling CO₂ concentrations in the atmosphere. DAC is the process of chemically scrubbing CO₂ from ambient air and then sequestering the CO₂ either underground or in long-lived products like concrete. Unlike CCUS, which will be discussed later, DAC removes excess carbon that has already been emitted into the atmosphere, instead of capturing the CO₂ at its source. CCUS is an industrial method that relies on collecting produced CO₂ (from sources like coal-fired power plants or other sources), and then utilizing the CO₂ for either reuse, conversion, or storage underground applications to prevent the CO₂ from dissipating into the atmosphere. Currently, CCUS projects are showcasing a research boom and are being used worldwide as industries strive for a more sustainable development.

One type of CCUS is known as carbon capture utilization by mineralization (CCUM). CCUM involves reacting minerals with CO₂ to turn CO₂ from a gas or aqueous phase to a solid phase, thereby removing CO₂ from the atmosphere. Carbon mineralization is a process that naturally occurs over hundreds or thousands of years in which certain mineral rocks react with atmospheric CO₂ to create carbonates. CO₂ is thermodynamically stable in the atmosphere. Thus, converting atmospheric CO₂ to a fuel source requires large amounts of energy. Although catalysts could be used reduce the required energy input, the CO₂ produced from the required energy input may exceed the CO₂ that is converted to fuel, resulting in a net increase in CO₂ production instead of a decrease. With that being said, in order to lower anthropogenic CO₂ emissions from the atmosphere, carbon mineralization remains desirable.

Two types of CCUM include in-situ (underground in geological formations) and ex-situ (aboveground in chemical processing plants). For in-situ carbon mineralization, CO₂ is transported to underground igneous rocks, such as basalts, and is fixated in the hosting rock in the form of solid carbonates. For ex-situ carbon mineralization, a source of alkaline earth metal feedstock is reacted with the CO₂ to produce solid carbonate rocks.

According to literature and without being bound to theory, carbon mineralization is suitable for mafic or ultramafic rocks, which are highly reactive with CO₂, as they contain alkaline minerals, such as magnesium or calcium-bearing silicates. The process of reacting CO₂ with naturally occurring rocks is known as natural carbon mineralization. Through these natural sink processes, carbon mineralization removes about 0.3 billion metric tons (gigatons) of CO₂ from the atmosphere each year. Alkalinity refers to the ability of water to resist acidification. Alkaline minerals include calcium (Ca), magnesium (Mg), bicarbonate, and others. While alkaline feedstock refers to raw materials such as alkaline rocks, industrial by-products or mine tailings that have been crushed and/or turned into powder can be used to mineralize CO₂. Mafic and ultramafic rocks are rich in alkaline minerals. Mafic rocks, such as basalts, are rich in iron, calcium and magnesium. Ultramafic rocks, such as peridotites, are rich in magnesium and iron. The mineral compositions of mafic and ultramafic rocks make both types highly reactive to CO₂. A challenge with this natural carbon mineralization process is its slow pace and long time duration required to achieve CO₂ mineralization. For example, such natural CO₂ mineralization can take up to hundreds or thousands of years. Therefore, in order to simulate the natural CO₂ mineralization process and accelerate the rate of reaction, the methods and systems described in this disclosure utilizes flowback produced water from hydraulically fractures wells to precipitate carbonates from CO₂ to capture and mineralize CO₂. Flowback produced water typically has a high total dissolved solids (TDS) content which includes calcium ions (Ca²⁺) and magnesium ions (Mg²⁺), which can be precipitated into calcium carbonates and magnesium carbonates, respectively.

There are different feedstocks for carbon mineralization processes aside from flowback produced water. Some feedstock examples include natural ores and alkaline industrial wastes. An advantage of natural ores as feedstock for carbon mineralization stems from their presence in nature. However, one disadvantage of natural ores as feedstock for carbon mineralization is related to their limited availability. As for alkaline wastes, an advantage stems from their accessibility at industrial plants and their low-cost pre-treatments. However, their disadvantages are related to the limited concentrations of alkaline earth metals, which can limit the rate of carbon minimization. Given these limitations of such feedstocks, utilizing flowback produced water as a source for carbon minimization process is desirable. Additionally, the disposal of flowback produced water has many health, safety, and environmental (HSE) concerns. To be exact, according to literature, the disposal of flowback produced water can have sublethal impacts and possess a toxicity toward different animal species due to their high TDS content. The TDS content of flowback produced water includes organic and inorganic materials, such as metals, minerals, salts, and ions, dissolved in a particular volume of water. TDS is a measure of anything dissolved in water that is a water molecule (H₂O). In flowback produced water, the TDS content can typically be tens to thousands of times greater than the limit for agricultural irrigations (for example, from about 100 milligrams per liter (mg/L) to about 1,000 mg/L). Thus, unprocessed flowback produced water cannot be used for irrigation purposes and could be a culprit for contaminating surface and underground waters. Furthermore, the TDS content in flowback produced water is typically hundreds to thousands of times greater than the drinking water limit (about 500 mg/L). This means that spills and improper disposal of flowback produced water can be potentially detrimental to ecosystems and affect drinking water safety. According to literature, the concentrations of Ca²⁺ and Mg²⁺ present in flowback produced water can be in a range from about 10 parts per million (ppm) to about 10,000 ppm and about 1 ppm to about 1,000 ppm, respectively. Further, the concentration of Ca²⁺ in flowback produced water can sometimes reach up to about 100,000 ppm. Such concentrations of these ions make flowback produced water a useful source for mineral carbonation. Given the challenges associated with flowback produced water disposal and the readily available ion concentrations of Ca²⁺/Mg²⁺, the use of flowback produced water can have a dual benefit of mitigating for the associated risks of flowback produced water disposal and serving as a source for carbon mineralization which can reduce the concentrations of CO₂ in the atmosphere.

This disclosure describes processing produced water to generate useful carbonates. The processing of produced water includes ex-situ carbon mineralization by reacting ion constituents of produced water (such as calcium ions and magnesium ions) with carbon dioxide to generate the carbonates. The carbon dioxide can be sourced from the flowback stream from hydraulic fracturing and/or from a process that generates carbon dioxide (such as fuel combustion). The produced water is filtered to separate calcium ions, magnesium ions, and carbon dioxide from a remainder of dissolved solids of the produced water. The calcium ions and magnesium ions are then reacted with the carbon dioxide in an alkaline environment to form carbonate precipitates. The carbonate precipitates can be separated, stored, and transported to users. The produced carbonates can, for example, be used in manufacturing and/or soil conditioner to improve soil structure and increase crop yield in agricultural fields. Processing produced water in this manner not only generates useful carbonates, but also captures carbon in the form of carbon dioxide, thereby reducing greenhouse gas emissions.

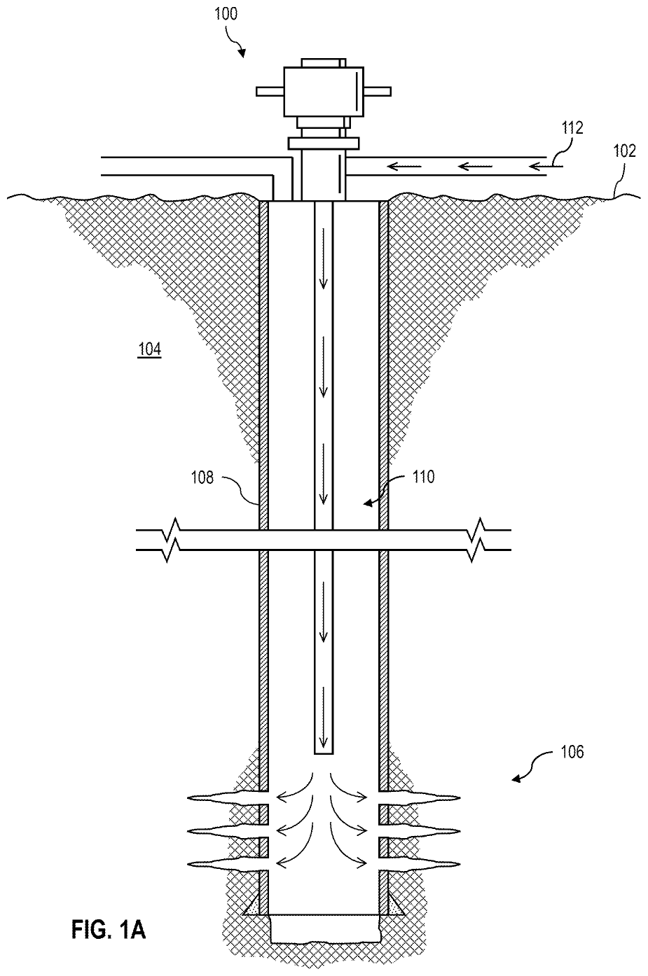

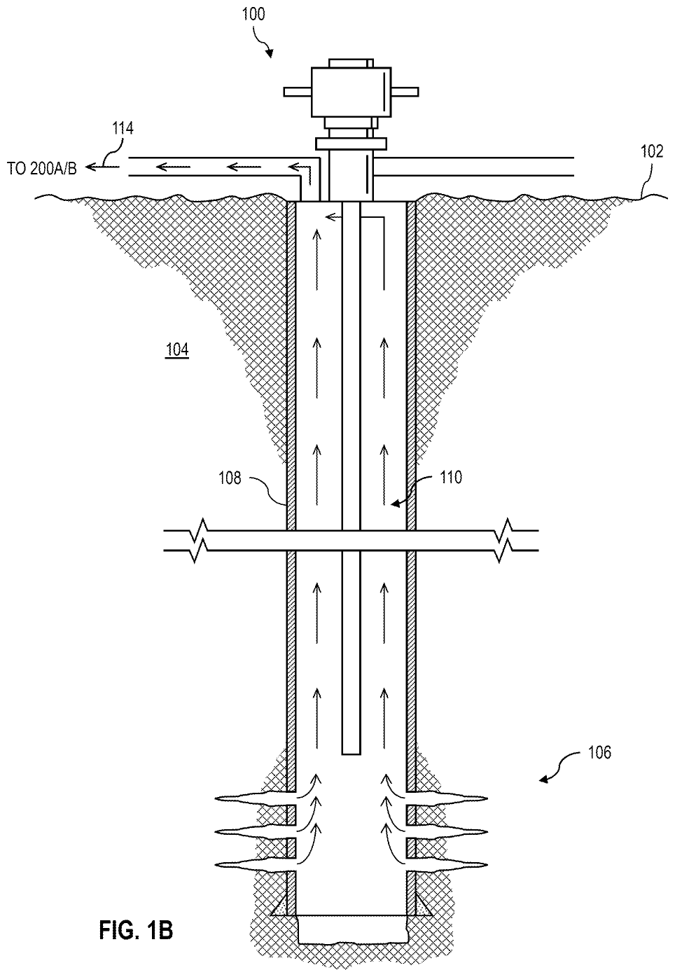

FIG. 1A depicts an example well 100 constructed in accordance with the concepts herein. The well 100 extends from the surface 102 through the Earth 104 to one more subterranean zones of interest 106 (one shown). The well 100 enables access to the subterranean zones of interest 106 to allow recovery (that is, production) of fluids to the surface 102 and, in some implementations, additionally or alternatively allows fluids to be placed in the Earth 104 (represented by flow arrows in FIG. 1A). In some implementations, the subterranean zone 106 is a formation within the Earth 104 defining a reservoir, but in other instances, the zone 106 can be multiple formations or a portion of a formation. The subterranean zone can include, for example, a formation, a portion of a formation, or multiple formations in a hydrocarbon-bearing reservoir from which recovery operations can be practiced to recover trapped hydrocarbons. In some implementations, the subterranean zone includes an underground formation of naturally fractured or porous rock containing hydrocarbons (for example, oil, gas, or both). In some implementations, the well can intersect other types of formations, including reservoirs that are not naturally fractured. For simplicity's sake, the well 100 is shown as a vertical well, but in other instances, the well 100 can be a deviated well with a wellbore deviated from vertical (for example, horizontal or slanted), the well 100 can include multiple bores forming a multilateral well (that is, a well having multiple lateral wells branching off another well or wells), or both.

In some implementations, the well 100 is a gas well that is used in producing hydrocarbon gas (such as natural gas) from the subterranean zones of interest 106 to the surface 102. While termed a “gas well,” the well need not produce only dry gas, and may incidentally or in much smaller quantities, produce liquid including oil, water, or both. In some implementations, the well 100 is an oil well that is used in producing hydrocarbon liquid (such as crude oil) from the subterranean zones of interest 106 to the surface 102. While termed an “oil well,” the well not need produce only hydrocarbon liquid, and may incidentally or in much smaller quantities, produce gas, water, or both. In some implementations, the production from the well 100 can be multiphase in any ratio. In some implementations, the production from the well 100 can produce mostly or entirely liquid at certain times and mostly or entirely gas at other times. For example, in certain types of wells it is common to produce water for a period of time to gain access to the gas in the subterranean zone. The concepts herein, though, are not limited in applicability to gas wells, oil wells, or even production wells, and could be used in wells for producing other gas or liquid resources or could be used in injection wells, disposal wells, or other types of wells used in placing fluids into the Earth.

The wellbore of the well 100 is typically, although not necessarily, cylindrical. All or a portion of the wellbore is lined with a tubing, such as casing 108. The casing 108 connects with a wellhead at the surface 102 and extends downhole into the wellbore. The casing 108 operates to isolate the bore of the well 100, defined in the cased portion of the well 100 by the inner bore 110 of the casing 108, from the surrounding Earth 104. The casing 108 can be formed of a single continuous tubing or multiple lengths of tubing joined (for example, threadedly) end-to-end. In particular, casing 108 is commercially produced in a number of common sizes specified by the American Petroleum Institute (the “API”), including 4½, 5, 5½, 6, 6⅝, 7, 7⅝, 7¾, 8⅝, 8¾, 9⅝, 9¾, 9⅞, 10¾, 11¾, 11⅞, 13⅜, 13½, 13⅝, 16, 18⅝, and 20 inches, and the API specifies internal diameters for each casing size. In some implementations, the casing 108 is omitted or ceases in the region of the subterranean zone of interest 106. This portion of the well 100 without casing is often referred to as “open hole.” The wellhead defines an attachment point for other equipment to be attached to the well 100. For example, FIG. 1A shows well 100 with a Christmas tree attached to the wellhead. The Christmas tree includes valves used to regulate flow into or out of the well 100.

In FIG. 1A, the casing 108 is perforated in the subterranean zone of interest 106 to allow fluid communication between the subterranean zone of interest 106 and the bore 110 of the casing 108. The perforations in the casing 108 can be formed, for example, during or before a hydraulic fracturing operation. Hydraulic fracturing (also referred to as fracking, hydrofracturing, or hydrofracking, for example) is a well stimulation technique that involves pumping fluid into a wellbore to form fractures in a formation. Hydraulic fracturing can increase the flow of one or more fluids in a well, which can in turn improve productivity of the well. Fracturing fluid 112 is injected into the well 100 at a rate that is sufficient to increase pressure at the target depth of the zone of interest 106 (for example, where the perforations in the casing 108 have been made) to exceed that of the fracture gradient (pressure gradient) of the rock formation. The fracture gradient is defined as pressure increase per unit of depth relative to density. As the fracturing fluid 112 is injected into the well 100, the rock formation cracks (fractures), and the fracturing fluid 112 permeates the rock formation, thereby extending the fracture further and further. The fractures formed in the rock formation can be localized as pressure drops off with the rate of frictional loss, which is relative to the distance from the well. In some implementations, the fracturing fluid 112 includes a proppant (such as grains of sand, ceramic, or other particulate), which can prevent the formed fractures from closing once injection of the fracturing fluid 112 into the well 100 is stopped, and the hydraulic pressure is removed. The fracturing fluid 112 can include, for example, a slurry, a gel, a foam, a compressed gas, or any combinations of these. In some implementations, the fracturing fluid 112 includes a chemical additive. Some suitable non-limiting examples of chemical additives that can be included in the fracturing fluid 112 include acids (such as hydrochloric acid or acetic acid), salt (such as sodium chloride), a friction reducer (such as polyacrylamide), a scale inhibitor (such as ethylene glycol), a viscosity modifier (such as borate, guar gum, or gelling agent), a crosslinker (such as sodium or potassium carbonates), biocide (such as glutaraldehyde), a corrosion inhibitor (such as citric acid), and an antifreeze (such as isopropanol). In some implementations, the fracturing fluid 112 includes a foam including carbon dioxide. The carbon dioxide included in the foam of the fracturing fluid 112 can, for example, be obtained from a process/system that produces carbon dioxide as a waste product.

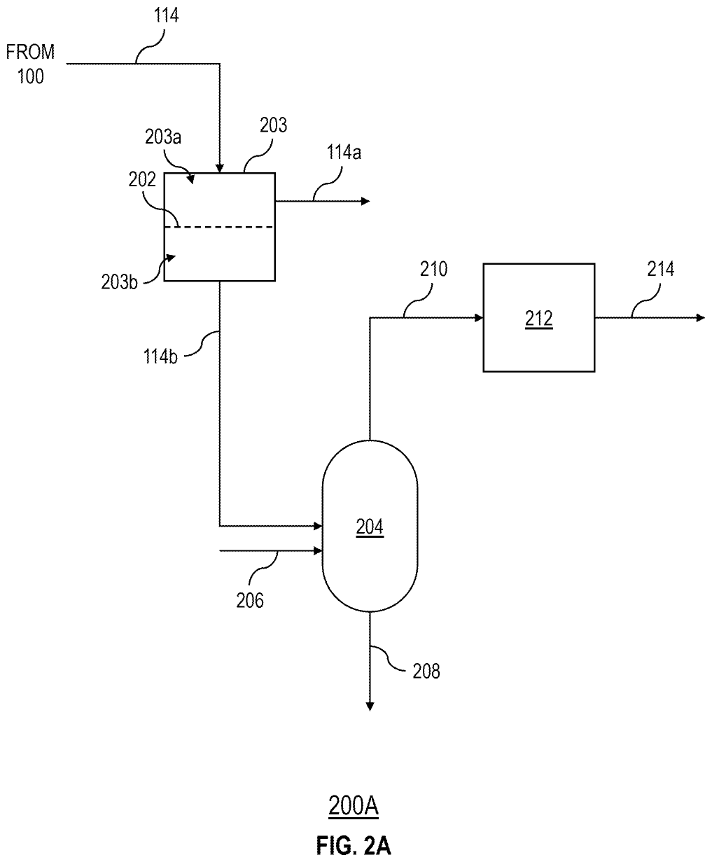

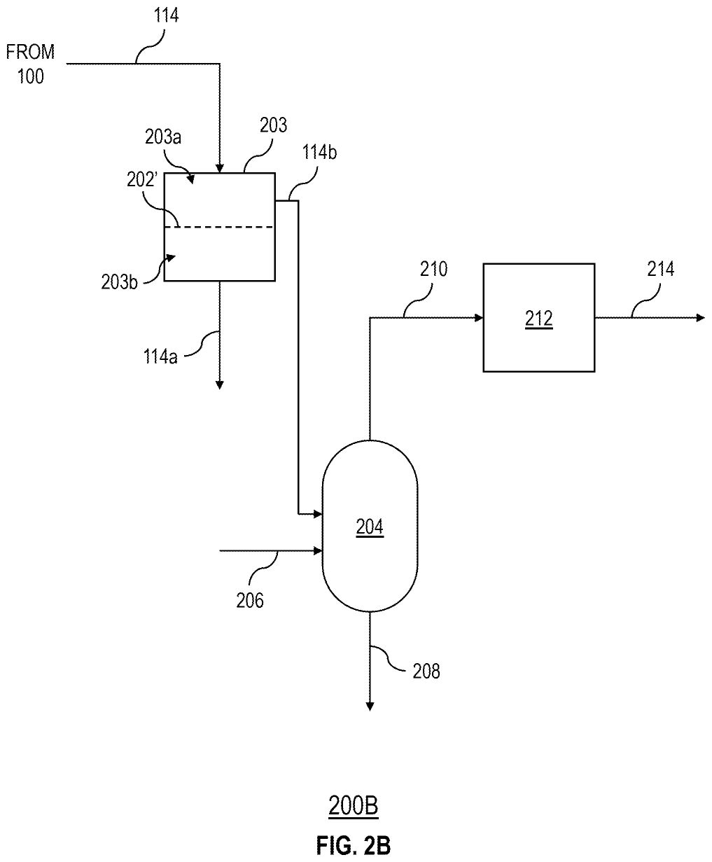

FIG. 1B depicts the well 100 after the fracturing fluid 112 has been injected into the well 100 and fracturing of the well 100 has completed. Flowback produced water 114 is flowed out of the well 100 and eventually to a flowback produced water processing unit 200A or 200B (which are shown in FIGS. 2A and 2B, respectively, and described in more detail later). The flowback produced water 114 can include at least a portion of the fracturing fluid 112 that was injected into the well 100 (for example, from about 10% to about 100% of the fracturing fluid 112). In some cases, the flowback produced water 114 may include formation water originating from the rock formation. The flowback produced water 114 can include, for example, dissolved solids (such as salt), water, and carbon dioxide. The dissolved solids of the flowback produced water 114 can be, for example, in the form of disassociated salt ions (cations and anions). In some implementations, the flowback produced water 114 includes divalent cations. For example, the flowback produced water 114 includes calcium ions (Ca²⁺), magnesium ions (Mg²⁺), or both. For example, the flowback produced water 114 has a concentration of magnesium ions that is about 6,000 parts per million (ppm) or greater. The flowback produced water 114 can include additional ions, such as chloride ions and strontium ions. For example, the flowback produced water 114 has a concentration of chloride ions that is about 10,000 ppm or greater. For example, the flowback produced water 114 has a concentration of strontium ions that is about 900 ppm or greater.

FIG. 2A is a schematic diagram of the flowback produced water processing unit 200A for capturing carbon from flowback produced water 114 from the well 100. The flowback produced water processing unit 200A includes a membrane 202. The membrane 202 can be disposed within a vessel 203. The membrane 202 can separate an inner volume of the vessel 203 into a first side 203a and a second side 203b. The vessel 203 can include an inlet at the first side 203a. The inlet at the first side 203a of the vessel 203 can be configured to receive the flowback produced water 114 from the well 100. The membrane 202 is semi-permeable, which allows certain components to pass through the membrane 202 while preventing other components from passing through the membrane 202. In some implementations, the membrane 202 is a nanofiltration (NF) membrane or other membrane that operates similarly as an NF membrane. In some implementations, the membrane 202 is made of polyamide or cellulose acetate. The membrane 202 can be configured to separate components of a fluid (and/or components carried by the fluid) based on electrical charge and/or size of the components. In some implementations, an operating temperature of the membrane 202 within the vessel 203 is in a range of from about 40 degrees Celsius (° C.) to about 55° C. In some implementations, the operating temperature of the membrane 202 within the vessel 203 is less than about 40° C. In some implementations, an operating pressure of the membrane 202 within the vessel 203 is in a range of from about 43.5 pounds per square inch gauge (psig, about 300 kilopascals gauge (300 kPag)) to about 435 psig (about 2,999 kPag).

In some implementations, the membrane 202 is configured to allow passage of carbon dioxide molecules, divalent cations, and water molecules through the membrane 202, while preventing at least a portion of the dissolved solids of the flowback produced water 114 from passing through the membrane 202. In such implementations, the carbon dioxide molecules, divalent cations (such as calcium ions (Ca²⁺) and magnesium ions (Mg²⁺)), and water molecules may pass from the first side 203a through the membrane 202 to the second side 203b, while a remaining portion of the flowback produced water 114 (for example, a remaining portion of the dissolved solids excluding the calcium ions (Ca²⁺) and magnesium ions (Mg²⁺)) remain at the first side 203a because the membrane 202 restricts such passage. The remaining portion of the flowback produced water 114 in the first side 203a is a waste fluid 114a, while the carbon dioxide molecules, divalent cations, and water molecules that have passed from the first side 203a through the membrane 202 to the second side 203b is a filtered flowback produced water 114b. Some water originating from the flowback produced water 114 may remain at the first side 203a of the vessel 203 based on osmotic pressure. The vessel 203 can include a first outlet at the first side 203a. The vessel 203 can include a second outlet at the second side 203b. The first outlet at the first side 203a of the vessel 203 can be configured to discharge the waste stream 114a from the vessel 203. The waste stream 114a exiting the vessel 203 includes some water and the remaining portion of the flowback produced water 114 from the first side 203a that includes the dissolved solids excluding the divalent cations that have passed through the membrane 202 to the second side 203b. The waste stream 114a exiting the vessel 203 can be, for example, disposed or processed to separate the dissolved solids from the water, such that the water may be reused. The second outlet at the second side 203b of the vessel 203 can be configured to discharge the filtered produced water stream 114b from the vessel 203. The filtered produced water stream 114b exiting the vessel 203 includes the carbon dioxide molecules, divalent cations, and water molecules that have passed from the first side 203a through the membrane 202 to the second side 203b.

The filtered produced water stream 114b flows from the vessel 203 to a reaction chamber 204. The reaction chamber 204 can include an inlet configured to receive the filtered produced water stream 114b. An alkali hydroxide 206 is flowed to the reaction chamber 204. In some implementations, the alkali hydroxide 206 is mixed with the filtered produced water stream 114b, and the mixture flows together into the reaction chamber 204 via the inlet. In some implementations, the alkali hydroxide 206 is flowed separately into the reaction chamber 204 from the filtered produced water stream 114b, for example, via another inlet of the reaction chamber 204. In some implementations, the fluid within the reaction chamber 204 (such as the mixture of the filtered produced water stream 114b and the alkali hydroxide 206) has a pH in a range of from about 7 to about 12. Within the reaction chamber 204, components of the filtered produced water stream 114b react with the alkali hydroxide 206. The alkali hydroxide 204 can include, for example, sodium hydroxide. Equations 1˜4 provide example chemical reactions that can occur within the reaction chamber 204.

CO_{2(aq)}+OH_{aq}⁻→HCO_{3(aq)}⁻ (1)

HCO_{3(aq)}⁻+OH_{(aq)}⁻→H₂O₍ₗ₎+CO_{3(aq)}²⁻ (2)

Ca_{(aq)}²⁺+HCO_{3(aq)}⁻→CaCO₃₍ₛ₎ (3)

Mg_{(aq)}²⁺+HCO_{3(aq)}⁻→MgCO₃₍ₛ₎ (4)

Equations 3 and 4 are partial equations that may be more comprehensively shown by Equations 3′ and 4′, respectively. Equation 3′ can be considered a combination of Equations 2 and 3. Equation 4′ can be considered a combination of Equations 2 and 4.

Ca_{(aq)}²⁺+HCO_{3(aq)}⁻+OH_{(aq)}⁻→CaCO₃₍ₛ₎+H₂O₍ₗ₎ (3′)

Mg_{(aq)}²⁺+HCO_{3(aq)}⁻+OH_{(aq)}⁻→MgCO₃₍ₛ₎+H₂O₍ₗ₎ (4′)

As shown in Equations 1, 2, 3, 3′, 4, and 4′, reacting the alkali hydroxide 206 with the filtered produced water stream 114b within the reaction chamber 204 results in the formation of carbonate precipitates (such as calcium carbonate (CaCO₃) and magnesium carbonate (MgCO₃)). In some implementations, the reaction chamber 204 is configured to operate at an operating temperature in a range of from about 50° C. to about 100° C. In some implementations, the reaction chamber 204 is configured to operate at an operating pressure in a range of from about 43.5 psig (about 300 kPag) to about 435 psig (about 2,999 kPag). The carbonate precipitates are solid and can be readily separated from the aqueous (liquid) phase. The reaction chamber 204 can include a first outlet configured to discharge the aqueous phase 208 from the reaction chamber 204. The aqueous phase 208 exiting the reaction chamber 204 via the first outlet of the reaction chamber 204 is a remaining portion of the filtered produced water stream 114b after undergoing reaction(s) within the reaction chamber 204 and excluding the solid phase (precipitates). The aqueous phase 208 exiting the reaction chamber 204 via the first outlet of the reaction chamber 204 can include, for example, water and ions. The aqueous phase 208 can flow from the reaction chamber 204 to a disposal area or into a second well (such as an injection well) formed in a subterranean formation. The reaction chamber 204 can include a second outlet configured to discharge the carbonate precipitates 210 from the reactor chamber 204. The carbonate precipitates 210 can include calcium carbonate (CaCO₃), magnesium carbonate (MgCO₃), or both.

The carbonate precipitates 210 can be transported to a production unit 212. The production unit 212 processes the carbonate precipitates 210 to produce a product 214. For example, in cases in which the carbonate precipitates 210 include calcium carbonate (CaCO₃), the production unit 212 includes a hopper configured to add the carbonate precipitates 210 to a formulation (mixture) for marble or cement. In such cases, the product 214 can include marble or cement (such as ready-mix cement or site mixed cement). The production unit 212 can be configured to produce both marble and cement, only marble, or only cement. As another example, in cases in which the carbonate precipitates 210 include magnesium carbonate (MgCO₃), the production unit 212 includes a hopper configured to add the carbonate precipitate 210 to a formulation for bricks, fire extinguisher containers, a cosmetic product, or a dusting powder. In such cases, the product 214 can include bricks, fire extinguisher containers, cosmetic products, or dusting powders. The production unit 212 can be configured to produce only bricks, only fire extinguisher containers, only cosmetic products, only dusting powders, or any combinations of bricks, fire extinguisher containers, cosmetic products, and dusting powders. In cases in which the production unit 212 produces multiple different products, the various different products can be shipped separately or together in any combination based on desired end goals.

FIG. 2B is a schematic diagram of the flowback produced water processing unit 200B for capturing carbon from flowback produced water 114 from the well 100. The flowback produced water processing unit 200B is substantially similar to the flowback produced water processing unit 200A shown in FIG. 2A, but the membrane 202′ of unit 200B is different from the membrane 202 of unit 200A. In some implementations, as shown in FIG. 2B, the membrane 202′ is configured to prevent passage of carbon dioxide molecules and divalent cations through the membrane 202′, while allowing a remaining portion of the flowback produced water 114 (such as a remaining portion of the dissolved solids) to pass through the membrane 202′. In such implementations, the carbon dioxide molecules and divalent cations (such as calcium ions (Ca²⁺) and magnesium ions (Mg²⁺)) remain at the first side 203a (because the membrane 202 restricts passage of such components from the first side 203a to the second side 203b through the membrane 202′), while a remaining portion of the flowback produced water 114 (such as a remaining portion of the dissolved solids) pass from the first side 203a through the membrane 202′ to the second side 203b. The carbon dioxide molecules and divalent cations and water molecules that remain at the first side 203a is a filtered flowback produced water 114b, while the portion of the flowback produced water 114 that has passed from the first side 203a through the membrane 202′ to the second side 203b is a waste fluid 114a. At least a portion of the water originating from the flowback produced water 114 may remain at the first side 203a of the vessel 203 based on osmotic pressure. In such implementations, the first outlet at the first side 203a can be configured to discharge the filtered produced water stream 114b from the vessel 203, and the second outlet at the second side 203b can be configured to discharge the waste stream 114a from the vessel 203. The remaining portions of the unit 200B (such as the reaction chamber 204 and production unit 212) can be the same as those of unit 200A.

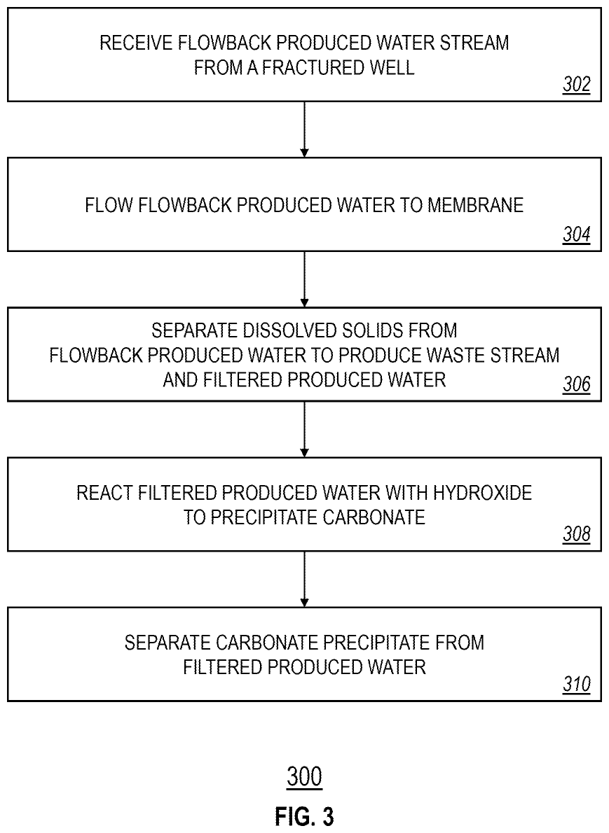

FIG. 3 is a flow chart of an example method 300 for processing flowback produced water from a well (such as the well 100) to capture carbon from the flowback produced water. The system 200A or 200B can, for example, implement the method 300. At block 302, a flowback produced water stream (such as the flowback produced water stream 114) is received at a surface location (such as the surface 102). As described previously, the flowback produced water stream 114 is from a hydraulically fractured well (100) that is formed in a subterranean formation. The flowback produced water stream 114 can include water, dissolved solids (for example, including divalent cations), and carbon dioxide. At block 304, the flowback produced water 114 is flowed to a membrane 202. The membrane 202 can be disposed within an inner volume of a vessel 203. Flowing the flowback produced water 114 to the membrane 202 at block 304 can include flowing the flowback produced water 114 into an inlet of the vessel 203 and to the membrane 202 within the vessel 203. The membrane 202 can separate the inner volume of the vessel 203 into a first side (203a) and a second side (203b). At block 306, the membrane 202 separates at least a portion of the dissolved solids from a remaining portion of the flowback produced water 114 to produce a waste stream (such as the waste stream 114a) and a filtered produced water stream (such as the filtered produced water stream 114b). The waste stream 114a includes the portion of the dissolved solids separated by the membrane 202 at block 306. The filtered produced water stream 114b includes the remaining portion of the flowback produced water 114. The waste stream 114a can reside within a first side (203a) of the vessel 203, while the filtered produced water stream 114b can reside within a second side (203b) of the vessel 203. The waste stream 114a can exit from the first side 203a of the vessel 203, for example, via a first outlet of the vessel 203. The filtered produced water stream 114b can exit from the second side 203b of the vessel 203, for example, via a second outlet of the vessel 203. At block 308, the filtered produced water stream 114b is reacted with an alkali hydroxide (such as the alkali hydroxide 206) to precipitate carbonates from the carbon dioxide molecules and the divalent cations. The filtered produced water stream 114b can be reacted with the alkali hydroxide 206 at block 308, for example, within the reaction chamber 204. Reacting the filtered produced water stream 114b with an alkali hydroxide 206 at block 308 can result in mineralization of the carbon from the filtered produced water stream 114a into carbonate precipitates 210. At block 310, the carbonate precipitates 210 are separated from a remainder of the filtered produced water 114a (such as the aqueous phase 208). In some implementations, the aqueous phase 208 is flowed into a second well (separate from the well 100) formed in a subterranean formation. In some implementations, the carbonate precipitates 210 can be processed by a production unit (such as the production unit 212) to produce a product (such as the product 214). Processing the carbonate precipitates 210 by the production unit 212 can, for example, include adding the carbonate precipitates 210 to a formulation for marble or cement. Processing the carbonate precipitates 210 by the production unit 212 can, for example, include adding the carbonate precipitates 210 to a formulation for a brick, a fire extinguisher, a cosmetic, or a dusting powder.

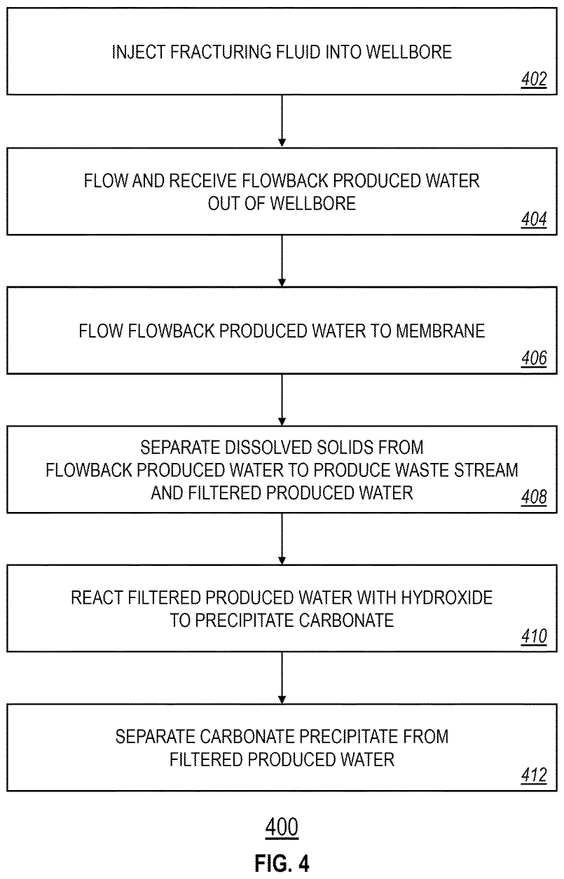

FIG. 4 is a flow chart of an example method 400 for processing flowback produced water from a well (such as the well 100) to capture carbon from the flowback produced water. The system 200A or 200B can, for example, implement the method 400. At block 402, a fracturing fluid (such as the fracturing fluid 112) is injected into a wellbore formed in a subterranean formation (such as the well 100). Injecting the fracturing fluid 112 into the well 100 at block 402 hydraulically fractures the subterranean formation. After injecting the fracturing fluid 112 into the well 100 at block 402, a flowback produced water stream (such as the flowback produced water stream 114) is flowed out of the well 100 and received at a surface location (such as the surface 102) at block 404. As described previously, the flowback produced water stream 114 is from a hydraulically fractured well (100) that is formed in a subterranean formation. The flowback produced water stream 114 can include water, dissolved solids (for example, including divalent cations), and carbon dioxide. At block 406, the flowback produced water 114 is flowed to a membrane 202. The membrane 202 can be disposed within an inner volume of a vessel 203. Flowing the flowback produced water 114 to the membrane 202 at block 406 can include flowing the flowback produced water 114 into an inlet of the vessel 203 and to the membrane 202 within the vessel 203. The membrane 202 can separate the inner volume of the vessel 203 into a first side (203a) and a second side (203b). At block 408, the membrane 202 separates at least a portion of the dissolved solids from a remaining portion of the flowback produced water 114 to produce a waste stream (such as the waste stream 114a) and a filtered produced water stream (such as the filtered produced water stream 114b). The waste stream 114a includes the portion of the dissolved solids separated by the membrane 202 at block 408. The filtered produced water stream 114b includes the remaining portion of the flowback produced water 114. The waste stream 114a can reside within a first side (203a) of the vessel 203, while the filtered produced water stream 114b can reside within a second side (203b) of the vessel 203. The waste stream 114a can exit from the first side 203a of the vessel 203, for example, via a first outlet of the vessel 203. The filtered produced water stream 114b can exit from the second side 203b of the vessel 203, for example, via a second outlet of the vessel 203. At block 410, the filtered produced water stream 114b is reacted with an alkali hydroxide (such as the alkali hydroxide 206) to precipitate carbonates from the carbon dioxide molecules and the divalent cations. The filtered produced water stream 114b can be reacted with the alkali hydroxide 206 at block 410, for example, within the reaction chamber 204. Reacting the filtered produced water stream 114b with an alkali hydroxide 206 at block 410 can result in mineralization of the carbon from the filtered produced water stream 114a into carbonate precipitates 210. At block 412, the carbonate precipitates 210 are separated from a remainder of the filtered produced water 114a (such as the aqueous phase 208). In some implementations, the aqueous phase 208 is flowed into a second well (separate from the well 100) formed in a subterranean formation. In some implementations, the carbonate precipitates 210 can be processed by a production unit (such as the production unit 212) to produce a product (such as the product 214). Processing the carbonate precipitates 210 by the production unit 212 can, for example, include adding the carbonate precipitates 210 to a formulation for marble or cement. Processing the carbonate precipitates 210 by the production unit 212 can, for example, include adding the carbonate precipitates 210 to a formulation for a brick, a fire extinguisher, a cosmetic, or a dusting powder.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

As used in this disclosure, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

As used in this disclosure, the term “about” or “approximately” can allow for a degree of variability in a value or range, for example, within 10%, within 5%, or within 1% of a stated value or of a stated limit of a range.

As used in this disclosure, the term “substantially” refers to a majority of, or mostly, as in at least about 50%, 60%, 70%, 80%, 90%, 95%, 96%, 97%, 98%, 99%, 99.5%, 99.9%, 99.99%, or at least about 99.999% or more.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “0.1% to about 5%” or “0.1% to 5%” should be interpreted to include about 0.1% to about 5%, as well as the individual values (for example, 1%, 2%, 3%, and 4%) and the sub-ranges (for example, 0.1% to 0.5%, 1.1% to 2.2%, 3.3% to 4.4%) within the indicated range. The statement “X to Y” has the same meaning as “about X to about Y,” unless indicated otherwise. Likewise, the statement “X, Y, or Z” has the same meaning as “about X, about Y, or about Z,” unless indicated otherwise.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described components and systems can generally be integrated together or packaged into multiple products.

Accordingly, the previously described example implementations do not define or constrain the present disclosure. Other changes, substitutions, and alterations are also possible without departing from the spirit and scope of the present disclosure.

### EMBODIMENTS

In an example implementation (or aspect), a method comprises: receiving, at a surface location, a flowback produced water stream from a hydraulically fractured well formed in a subterranean formation, wherein the flowback produced water stream comprises water, dissolved solids comprising divalent cations, and carbon dioxide; flowing the flowback produced water to a membrane; separating, by the membrane, at least a portion of the dissolved solids from a remaining portion of the flowback produced water to produce a waste stream comprising the portion of the dissolved solids separated by the membrane and a filtered produced water stream comprising the remaining portion of the flowback produced water, wherein the membrane is configured to allow passage of divalent cations, water molecules, and carbon dioxide molecules through the membrane while preventing at least the portion of the dissolved solids from passing through the membrane, such that the filtered produced water stream comprises the divalent cations, water molecules, and carbon dioxide molecules; reacting the filtered produced water stream with an alkali hydroxide to precipitate carbonates from the carbon dioxide molecules and the divalent cations, thereby mineralizing the carbon from the filtered produced water stream into carbonate precipitates; and separating the carbonate precipitates from a remainder of the filtered produced water stream.

In an example implementation (or aspect) combinable with any other example implementation (or aspect), the alkali hydroxide is selected from the group consisting of sodium hydroxide and potassium hydroxide.

In an example implementation (or aspect) combinable with any other example implementation (or aspect), the divalent cations comprise calcium cations, and the carbonate precipitates comprise calcium carbonate.

In an example implementation (or aspect) combinable with any other example implementation (or aspect), the method further comprises: adding the calcium carbonate in a formulation for marble or cement; and flowing the filtered produced water stream into a second well formed in the subterranean formation.

In an example implementation (or aspect) combinable with any other example implementation (or aspect), the divalent cations comprise magnesium cations, and the carbonate precipitates comprise magnesium carbonate.

In an example implementation (or aspect) combinable with any other example implementation (or aspect), the method further comprises: adding the magnesium carbonate in a formulation for a brick, a fire extinguisher, a cosmetic, or a dusting powder; and flowing the filtered produced water stream into a second well formed in the subterranean formation.

In an example implementation (or aspect), a method comprises: injecting a fracturing fluid comprising carbon dioxide into a wellbore formed in a subterranean formation, thereby hydraulically fracturing the subterranean formation; after injecting the fracturing fluid into the wellbore to hydraulically fracture the subterranean formation, flowing a flowback produced water stream out of the wellbore and receiving the flowback produced water stream at a surface location, wherein the flowback produced water stream comprises dissolved solids and water from the subterranean formation and at least a portion of the fracturing fluid; flowing the flowback produced water stream to a membrane located at the surface location; separating, by the membrane, at least a portion of the dissolved solids from a remaining portion of the flowback produced water stream to produce a waste stream comprising the portion of the dissolved solids separated by the membrane and a filtered produced water stream comprising the remaining portion of the flowback produced water stream; reacting the filtered produced water stream with an alkali hydroxide to precipitate carbonates from the carbon dioxide molecules and at least a portion of the dissolved solids, thereby mineralizing the carbon from the filtered produced water stream into carbonate precipitates; and separating the carbonate precipitates from a remainder of the filtered produced water stream.

In an example implementation (or aspect) combinable with any other example implementation (or aspect), the alkali hydroxide is selected from the group consisting of sodium hydroxide and potassium hydroxide.

In an example implementation (or aspect) combinable with any other example implementation (or aspect), the divalent cations comprise calcium cations, and the carbonate precipitates comprise calcium carbonate.

In an example implementation (or aspect) combinable with any other example implementation (or aspect), the method further comprises: adding the calcium carbonate in a formulation for marble or cement; and flowing the filtered produced water stream into a second well formed in the subterranean formation.

In an example implementation (or aspect) combinable with any other example implementation (or aspect), the divalent cations comprise magnesium cations, and the carbonate precipitates comprise magnesium carbonate.

In an example implementation (or aspect) combinable with any other example implementation (or aspect), the method further comprises: adding the magnesium carbonate in a formulation for a brick, a fire extinguisher, a cosmetic, or a dusting powder; and flowing the filtered produced water stream into a second well formed in the subterranean formation.

In an example implementation (or aspect), a system comprises: a flowback produced water stream from a wellbore formed in a subterranean formation, wherein the flowback produced water stream comprises carbon dioxide, dissolved solids comprising divalent cations, and water; a membrane positioned at a surface location, wherein the membrane is configured to allow passage of carbon dioxide molecules, divalent cations, and water molecules through the membrane while preventing at least a portion of the dissolved solids from passing through the membrane, wherein the membrane is configured to separate the portion of the dissolved solids from a remaining portion of the flowback produced water stream to produce a waste stream comprising the portion of the dissolved solids separated by the membrane and a filtered produced water stream comprising the remaining portion of the flowback produced water, wherein the filtered produced water stream comprises the divalent cations, the carbon dioxide molecules, and the water molecules; an inlet flowline in fluid communication with the membrane, wherein the inlet flowline is configured to flow the flowback produced water stream to the membrane; an outlet flowline in fluid communication with the membrane, wherein the outlet flowline is configured to flow the waste stream away from the membrane; a reaction chamber configured to receive the filtered produced water stream and an alkali hydroxide, wherein the reaction chamber is configured to hold the filtered produced water stream and the alkali hydroxide for a specified time duration to react the filtered produced water stream with the alkali hydroxide to precipitate carbonates from the carbon dioxide molecules and the divalent cations, thereby mineralizing the carbon from the filtered produced water stream into carbonate precipitates; and an intermediate flowline in fluid communication with the membrane and the reaction chamber, wherein the intermediate flowline is configured to flow the filtered produced water stream from the membrane to the reaction chamber.

In an example implementation (or aspect) combinable with any other example implementation (or aspect), the system further comprises a second outlet flowline in fluid communication with the reaction chamber, wherein the second outlet flowline is configured to flow a remaining portion of the filtered produced water stream free of the carbonate precipitates from the reaction chamber to a second well formed in the subterranean formation.

In an example implementation (or aspect) combinable with any other example implementation (or aspect), the alkali hydroxide is selected from the group consisting of sodium hydroxide and potassium hydroxide.

In an example implementation (or aspect) combinable with any other example implementation (or aspect), the divalent cations comprise calcium cations, and the carbonate precipitates comprise calcium carbonate.

In an example implementation (or aspect) combinable with any other example implementation (or aspect), the system further comprises a production unit, wherein the production unit is configured to receive the calcium carbonate and add the calcium carbonate to a cement formulation to produce cement or to a marble formulation to produce marble.

In an example implementation (or aspect) combinable with any other example implementation (or aspect), the divalent cations comprise magnesium cations, and the carbonate precipitates comprise magnesium carbonate.

In an example implementation (or aspect) combinable with any other example implementation (or aspect), the system further comprises a brick production unit, wherein the brick production unit is configured to receive the magnesium carbonate and add the magnesium carbonate to a brick formulation to produce brick.

What is claimed is:

1. A method comprising:
receiving, at a surface location, a flowback produced water stream from a hydraulically fractured well formed in a subterranean formation, wherein the flowback produced water stream comprises water, dissolved solids comprising divalent cations, and carbon dioxide;
flowing the flowback produced water to a membrane;
separating, by the membrane, at least a portion of the dissolved solids from a remaining portion of the flowback produced water to produce a waste stream comprising the portion of the dissolved solids separated by the membrane and a filtered produced water stream comprising the remaining portion of the flowback produced water, wherein the membrane is configured to allow passage of divalent cations, water molecules, and carbon dioxide molecules through the membrane while preventing at least the portion of the dissolved solids from passing through the membrane, such that the filtered produced water stream comprises the divalent cations, water molecules, and carbon dioxide molecules;
reacting the filtered produced water stream with an alkali hydroxide to precipitate carbonates from the carbon dioxide molecules and the divalent cations, thereby mineralizing the carbon from the filtered produced water stream into carbonate precipitates; and
separating the carbonate precipitates from a remainder of the filtered produced water stream.

2. The method of claim 1, wherein the alkali hydroxide is selected from the group consisting of sodium hydroxide and potassium hydroxide.

3. The method of claim 2, wherein the divalent cations comprise calcium cations, and the carbonate precipitates comprise calcium carbonate.

4. The method of claim 3, further comprising:
adding the calcium carbonate in a formulation for marble or cement; and
flowing the filtered produced water stream into a second well formed in the subterranean formation.

5. The method of claim 2, wherein the divalent cations comprise magnesium cations, and the carbonate precipitates comprise magnesium carbonate.

6. The method of claim 5, further comprising:
adding the magnesium carbonate in a formulation for a brick, a fire extinguisher, a cosmetic, or a dusting powder; and
flowing the filtered produced water stream into a second well formed in the subterranean formation.

7. A method comprising:
injecting a fracturing fluid comprising carbon dioxide into a wellbore formed in a subterranean formation, thereby hydraulically fracturing the subterranean formation;
after injecting the fracturing fluid into the wellbore to hydraulically fracture the subterranean formation, flowing a flowback produced water stream out of the wellbore and receiving the flowback produced water stream at a surface location, wherein the flowback produced water stream comprises dissolved solids and water from the subterranean formation and at least a portion of the fracturing fluid;
flowing the flowback produced water stream to a membrane located at the surface location;
separating, by the membrane, at least a portion of the dissolved solids from a remaining portion of the flowback produced water stream to produce a waste stream comprising the portion of the dissolved solids separated by the membrane and a filtered produced water stream comprising the remaining portion of the flowback produced water stream;
reacting the filtered produced water stream with an alkali hydroxide to precipitate carbonates from the carbon dioxide molecules and at least a portion of the dissolved solids, thereby mineralizing the carbon from the filtered produced water stream into carbonate precipitates; and
separating the carbonate precipitates from a remainder of the filtered produced water stream.

8. The method of claim 7, wherein the alkali hydroxide is selected from the group consisting of sodium hydroxide and potassium hydroxide.

9. The method of claim 8, wherein the divalent cations comprise calcium cations, and the carbonate precipitates comprise calcium carbonate.

10. The method of claim 9, further comprising:
adding the calcium carbonate in a formulation for marble or cement; and
flowing the filtered produced water stream into a second well formed in the subterranean formation.

11. The method of claim 8, wherein the divalent cations comprise magnesium cations, and the carbonate precipitates comprise magnesium carbonate.

12. The method of claim 11, further comprising:
adding the magnesium carbonate in a formulation for a brick, a fire extinguisher, a cosmetic, or a dusting powder; and
flowing the filtered produced water stream into a second well formed in the subterranean formation.

13. A system comprising:
a flowback produced water stream from a wellbore formed in a subterranean formation, wherein the flowback produced water stream comprises carbon dioxide, dissolved solids comprising divalent cations, and water;
a membrane positioned at a surface location, wherein the membrane is configured to separate a portion of the dissolved solids from a remaining portion of the flowback produced water stream to produce a waste stream comprising the portion of the dissolved solids separated by the membrane and a filtered produced water stream comprising the remaining portion of the flowback produced water, wherein the filtered produced water stream comprises the divalent cations, the carbon dioxide molecules, and the water molecules;
an inlet flowline in fluid communication with the membrane, wherein the inlet flowline is configured to flow the flowback produced water stream to the membrane;
an outlet flowline in fluid communication with the membrane, wherein the outlet flowline is configured to flow the waste stream away from the membrane;
a reaction chamber configured to receive the filtered produced water stream and an alkali hydroxide, wherein the reaction chamber is configured to hold the filtered produced water stream and the alkali hydroxide for a specified time duration to react the filtered produced water stream with the alkali hydroxide to precipitate carbonates from the carbon dioxide molecules and the divalent cations, thereby mineralizing the carbon from the filtered produced water stream into carbonate precipitates; and
an intermediate flowline in fluid communication with the membrane and the reaction chamber, wherein the intermediate flowline is configured to flow the filtered produced water stream from the membrane to the reaction chamber.

14. The system of claim 13, further comprising a second outlet flowline in fluid communication with the reaction chamber, wherein the second outlet flowline is configured to flow a remaining portion of the filtered produced water stream free of the carbonate precipitates from the reaction chamber to a second well formed in the subterranean formation.

15. The system of claim 14, wherein the alkali hydroxide is selected from the group consisting of sodium hydroxide and potassium hydroxide.

16. The system of claim 15, wherein the divalent cations comprise calcium cations, and the carbonate precipitates comprise calcium carbonate.

17. The system of claim 16, further comprising a production unit, wherein the production unit is configured to receive the calcium carbonate and add the calcium carbonate to a cement formulation to produce cement or to a marble formulation to produce marble.

18. The system of claim 15, wherein the divalent cations comprise magnesium cations, and the carbonate precipitates comprise magnesium carbonate.

19. The system of claim 18, further comprising a brick production unit, wherein the brick production unit is configured to receive the magnesium carbonate and add the magnesium carbonate to a brick formulation to produce brick.
